(19) United States
(12) Patent Application Publication
(10) Pub. No.: US 2026/0237135 A1
(43) Pub. Date: Aug. 13, 2026

(54) PERSONALIZED REPRESENTATION AND ANIMATION OF HUMANOID CHARACTERS

(71) Applicant: PICTORYTALE AS, Kristiansand S (NO)

(72) Inventors: Suraj PRABHAKARAN, Aachen (DE); Håkon GUNDERSEN, Oslo (NO)

(21) Appl. No.: 19/164,482

(22) PCT Filed: Mar. 14, 2024
(86) PCT No.: PCT/NO2024/050064

§ 371 Date: Sep. 11, 2025

(30) Foreign Application Priority Data
Mar. 14, 2023 (NO) 20230273

(51) Int. Cl. G06T 13/40; G06V 10/82; G06V 20/40

(52) U.S. Cl. CPC G06T 13/40; G06V 10/82; G06V 20/41

(57) ABSTRACT

In a computer device a library of personalization data for use in animation of a 3D model representing a human or a humanoid character in a shared VR or AR environment is maintained. The personalization data includes at least animation, texture or color description that represent mannerisms or idiosyncrasies of an individual, for example when performing gestures or facial expressions. The personalization data is stored as an indexed file or library which is made available to other participants in the shared environment. When animation description data is generated, indices referencing detected actions are transmitted together with animation description data to the shared environment. Other participants apply the referenced actions from the library together with animation data when rendering the 3D model. Aspects include methods and devices for creating personalization data, including personalization data indices with animation data, and for applying personalization data when rendering an animation.

### TECHNICAL FIELD

The present invention relates to representations of humans or humanoid characters in 3D animation, such as in virtual reality (VR) and augmented reality (AR) environments. In particular, the invention relates to personalization of such representations, in particular, but not exclusively, with respect to motions, gestures, and expressions.

### BACKGROUND

Humans are typically represented in AR and VR environments as 3D characters or volumetric characters. 3D characters are generally represented in accordance with popular 3D file formats used in the film industry or for AR and VR purposes. Examples of such file formats include FBX, OBJ, GLB, and USD. A 3D file typically stores representations of one or more of the four types of data: model geometry, model surface texture, scene details, and animation of the model. The file formats do not necessarily store the same types of data for representation. For example, an OBJ file does not store any animation data, while an FBX file stores all animation data.

All these file formats are generic in nature. This means that they are meant to represent any 3D model and not only 3D representation of human or humanoid characters. In other words, these 3D file formats do not take advantage of features and limitations that are specific to the human anatomy, and neither do they include features that are specifically adapted to represent idiosyncrasies that are specific to individuals, but within limitations dictated by anatomy or meaning. For example, gestures and facial expressions are limited by human anatomy, and their significance is limited by the extent to which an observer will associate a given gesture or expression with meaning. (Admittedly, motion capture and skeletal representations are limited by human anatomy, but not in the sense discussed herein.) Traditional file formats' inability to exploit the specifics of human anatomy and individual mannerisms results in several limitations and disadvantages, especially in live interaction between participants who are represented as 3D characters in a shared AR or VR environment. Such shared environments may also be referred to as a metaverse or the metaverse. This term should not be interpreted as referring to only one specific implementation of a shared environment, neither should it be interpreted as referring to any specific technology with respect to representation of the environment, whether it is represented on one or several computers, whether it is a single shared environment or a collection of several shared environments that are connected to each other, and so on.

In order to illustrate the shortcomings of traditional file formats, consider a metaverse where user A is represented as a 3D character in an AR environment and that this representation of user A can be observed by user B who is in a different location. In this scenario, user A stands in front of a camera and interacts with user B, while user B sees user A as a 3D character in AR. The representation of user A will perform gestures (body and face) that are synchronized with those actually performed by user A. This is achieved through the use of a motion capture module which generates representations of motion as animation data and the animation data is transferred over a network and applied to the 3D representation of user A displayed on user B's device. These animations are usually generic in the sense that all motion is represented in the same manner, regardless of what it is that moves and how it moves. For example, in the case of Joint based animations or skeletal animation, the vertices are captured and transferred over the network which are then applied on the 3D character of user A.

Two disadvantages associated with this method are readily apparent. First, the accuracy of the animation is only as good as the situation allows in each actual situation with respect to capture and transfer of vertices. Typically, with only a single camera, perhaps only a handheld cellphone, limited vertex movements can be captured. In production situations advanced motion capture tools use either multiple cameras surrounding the subject or a single camera with post processing by software tools which. While providing rich and accurate vertex movement information, this is not suitable for live transfer, for example in a conference or gaming situation.

Secondly, the animation information is not personalized. Since the 3D characters file formats are generic and the animations lack accuracy, the expressions and gestures captured are not able to convey personalized details. For example, while one person may smile with equal movement of the lips on both sides of the cheek, another person's natural smile may differ in the way the lips move, for example by being asymmetric. While it may be possible to capture such details in a professional studio environment, it is normally not something that can be readily done in a standard 3D model animation made by users.

In view of this it is desirable to introduce new methods and systems that can facilitate richer and more personalized animation of 3D characters that represent users engaged in interaction in a VR or an AR environment.

### SUMMARY OF THE DISCLOSURE

In view of the shortcomings described above, the present invention provides methods and devices that aim at providing a richer and more personalized representation of humanoid characters by providing ways of capturing and presenting actions that include personalized behavior in the form of gestures, facial expressions and more. The invention includes three interrelated products, or aspects, namely a method and a device for creating personalization data, a method and device for using or including the personalization data when creating an animation, and a method and a device for applying the personalization data when rendering an animated 3D model in order to present personalized animation of the model. Two or more of these aspects may be combined in embodiments of the invention, but typically the creation of personalization data is performed in conjunction with the creation of the 3D model (i.e., it creates the “vocabulary” of personalized actions) independently of any actual session where animation data is exchanged. The use of personalization data is performed when the animation data that will be used to animate the 3D model is created (i.e., it is the use of the personalization “vocabulary” on the transmitting end or part of a session). Finally, the application of the personalization data to a rendered animation of a 3D model is performed at the receiving end for presentation (i.e., it is the reception and presentation of actions from the “vocabulary”).

According to the first aspect a method is provided for, in a computer system, creation of a library of personalization data for use in animation of a 3D model representing a human or a humanoid character in a shared environment. The method includes obtaining a video stream of a user while the user is performing a sequence of actions, providing frames from the video stream as input to a computerized process of analyzing the frames in order to detect one or more actions performed by the user, identifying the detected one or more actions, and for the detected one or more actions, extracting action description data from the video frames and storing the action description data in a library of personalization data. The action description data includes encoded aspects of the detected one or more actions, and the respective action descriptions are associated with an index.

In some embodiments frames from the video stream are provided as input to a computerized process of photogrammetry to generate 3D information about the user. The 3D information may then be used to generate a 3D representation of the user, and the 3D representation of the user may be stored as a 3D model that may be represented and animated in the shared environment.

Embodiments of the invention may, in order to analyze the frames and detect one or more actions and identify the one or more detected actions, utilize a machine learning subsystem that has been trained to perform at least one of detecting and identifying actions in a stream of video frames. Such a machine learning subsystem may include at least one artificial neural network.

Some embodiments of the invention may be configured to infer, based on the action description data for at least one detected action, an estimated action description for at least one action that has not been detected. The estimated action description may then be indexed and stored in the library of personalization data along with the action descriptions based on detected actions.

The action descriptions may include at least one of animation data, texture data, and color data.

A computer device according to the first aspect, for creating a library of personalization data for use in animation of a 3D model representing a human or a humanoid character in a shared environment, is also provided. Such a computer device includes at least one video camera, a personalization data creation module configured to receive frames from the at least one video camera, and including a sub-module configured to analyze received video frames and detect actions performed by a user depicted in the video frames, and a sub-module configured to identify detected actions and extract action description data including encoded aspects of the detected one or more actions, and associating each action description with an index. The device also includes a storage unit configured to receive and store personalization data received from the data creation module.

A computer device according to this aspect of the invention may also include a 3D model creation module configured to receive frames from the at least one video camera and use photogrammetry processing of the video frames to generate a 3D model based on images of a person represented in the received video frames. At least one of the sub-modules configured to detect actions and the sub-module configured to identify actions may include an artificial neural network.

In accordance with the second aspect of the invention, a method is provided for, in a computer system, provide personalization data together with animation data for animation of a 3D model representing a human or a humanoid character in a shared environment. The method includes connecting to the shared environment, transmitting, to the shared environment, a library of personalization data holding action description data including encoded aspects of one or more actions, each action description being associated with an index, obtaining a video stream of a user while the user is performing actions, providing frames from the video stream as input to a computerized process of motion capture to generate animation data from user movement represented in the video stream, providing frames from the video stream as input to a computerized process of analyzing the frames in order to detect and identify at least one action corresponding to an action represented in the library of personalization data, and transmitting the generated animation data and the index for the detected and identified at least one action to the shared environment.

A method according to this aspect may perform at least one of detecting one or more actions and identifying the one or more detected actions, using a machine learning subsystem that has been trained to perform at least one of detecting and identifying actions in a stream of video frames. Such a machine learning subsystem may include at least one artificial neural network. The action description includes at least one of: animation data, texture data, and color data.

A computer device according to the second aspect includes a storage unit storing a library of personalization data holding action description data including encoded aspects of one or more actions, each action description being associated with an index, a video camera, an animation module configured to receive frames from the at least one video camera, and including a sub-module configured to perform motion capture processing of the received video frames to generate animation data from movements performed by a person represented in the video stream, a sub-module configured to analyze video frames and detect actions performed by a person depicted in the video frames, and a sub-module configured to identify detected actions and obtain indices associated with identified actions from the storage unit, and a communications interface configured to transmit the library of personalization data, animation data and action indices to the shared environment.

In the third aspect of the invention, a method is provided of, in a computer system, applying personalization data to animation data when animating a 3D model representing a human or a humanoid character in a shared environment. The method includes connecting to the shared environment, receiving a library of personalization data holding action description data including encoded aspects of one or more actions, each action description being associated with an index, receiving animation data and at least one index referencing an action represented in the library of personalization data, using the at least one index to retrieve action description data from the library of personalization data, applying retrieved action description data to the animation data to generate personalization animation data, and rendering and animating the 3D model in accordance with the personalization animation data.

In some embodiments such a method includes receiving the 3D model together with the library of personalization data. The library of personalization data may be received from a repository connected to a computer network, and the animation data and the at least one index referencing an action represented in the library of personalization data may be received from a device participating in the shared environment. In some embodiments the personalization data has been generated independently from the generation of the 3D model.

A computer device configured to operate in accordance with this aspect of the invention includes a communications interface for receiving a library of personalization data holding action description data including encoded aspects of one or more actions, each action description being associated with an index, animation data and indices referencing actions represented in libraries of personalization data from the shared environment, a rendering module (206) configured to include the 3D model in a local representation of the shared environment (209), to retrieve action description data referenced by received indices from the library of personalization data, to apply retrieved action description data to animation data to generate personalization animation data, and to render and animate the 3D model in accordance with the personalization animation data, and a display unit configured to visualize at least a part of the shared environment including rendered and animated 3D models.

### BRIEF DESCRIPTION OF THE DRAWINGS

The invention will now be described in further detail with reference to the drawings, where:

FIG. 1 shows a simplified representation of three faces with different personalized facial expressions;

FIG. 2 illustrates in a block diagram, an embodiment of a client device 200 configured to operate in accordance with the invention;

FIG. 3 is a flowchart illustrating an exemplary embodiment of a method of creating personalization data;

FIG. 4 is a flowchart illustrating an exemplary embodiment of a method of creating and transmitting animation data and personalization data indices;

FIG. 5 is a flowchart illustrating an exemplary embodiment of a method of receiving animation data and personalization data indices and of using referenced personalization data to enhance the animation data when animating and rendering a 3D model; and

FIG. 6 is a block diagram illustrating the flow of data between two devices connected to the same shared environment.

### DETAILED DESCRIPTION

The present invention relates generally to 3D animation. More specifically, the present disclosure describes methods and systems for animation of 3D representations of humans or humanoid characters, particularly 3D representations of users in VR or AR environments. More particularly, embodiments of the present invention may be configured to provide personalization of animation of such 3D representations based on captured gestures, facial expressions and other mannerisms that are specific to individual users or in other ways related to a specific character or representation.

In the following description of various embodiments, reference will be made to the drawings, in which like reference numerals denote the same or corresponding elements. It will be realized that while many features are required for a computer-based system to operate, some features are well known in the art and present in most systems. The present disclosure will not dwell unnecessary on such details. Instead, features the description of which will facilitate understanding of the invention will be prioritized, while less important details may be given a somewhat simplified or schematic presentation. For some features it will be assumed that a person skilled in the art will be able to provide the necessary contextual information from general knowledge in the field. As such, certain conventional elements may have been left out in the interest of exemplifying the principles of the invention rather than cluttering the drawings and the disclosure with details that do not contribute to the understanding of these principles.

It should be noted that, unless otherwise stated, different features or elements may be combined with each other whether or not they have been described together as part of the same embodiment below. The combination of features or elements in the exemplary embodiments are done in order to facilitate understanding of the invention rather than limit its scope to a limited set of embodiments, and to the extent that alternative elements with substantially the same functionality are shown in respective embodiments, they are intended to be interchangeable, but for the sake of brevity, no attempt has been made to disclose a complete description of all possible permutations of features.

Furthermore, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention.

In the present disclosure the term personalized, or personalization, will be used repeatedly. This term should be understood in a technical sense. In many, or most, cases personalization will refer to something that is specific to an individual, real or artificial, and a few things should be kept in mind. First, personalization does not require uniqueness. Personalization data is data that describes aspects of representation and animation that can be experienced as being idiosyncratic, but in principle personalization data can be identical for representations of different individuals. Second, personalization does not have to be derived from the represented individual. Instead, personalization data that has been created by other means may be applied to a representation of an individual. In other words, while personalization data may be derived from the individual that is represented, and may be unique to that individual, this does not have to be the case. For consistency, the data will be referred to as personalization data regardless of how it has been created and whether the same data is applied to more than representations of more than one individual. Similarly, the term individual will be used to refer to that which is represented, whether this is a real person or an imagined character, and whether the individual is pre-recorded or interacting with a VR or AR environment in real time.

The following terminology will be adhered to in the main, but any deviations therefrom should be interpreted from context. A user is a person using or interacting with a system that implements one or more features of the present invention. An individual is a representation in a system of a human or humanoid character which may be a real (a user) or fictional (a character). A model, or a 3D model, is a data structure that realizes, or is, the representation. As such, a 3D representation is a 3D model that represents a user or a character in the shared environment.

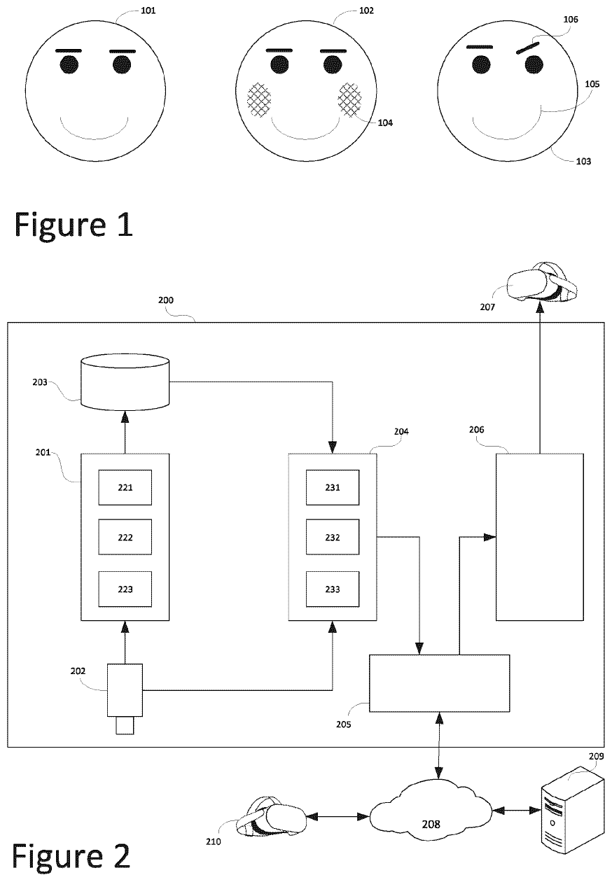

Thus, a 3D representation, in the context of the present disclosure, is a 3D model of a human or a humanoid character. In accordance with the invention this representation includes, or is supplied or associated with, personalization data. A 3D representation may typically include four types of data. Model geometry, surface texture, traditional animation data, and personalization data. The model geometry may typically be represented as a mesh, a skeleton, geometric primitives, and combinations of these, connected to each other in defined relationships which influences how movement of one point or vertex in the geometric model may influence movement in other parts of the model. The personalization data may interact with or influence at least one of the texture data and the animation data during rendering. For example, as illustrated schematically in FIG. 1, a generic smile might be a symmetrical upwards movement of the edges of the mouth as represented by the first face 101. One person may perhaps blush when smiling, as represented by the second face 102. This reddening of the cheeks 104 may be represented by a change in the texture data for the relevant part of the 3D model. Another person, represented here by a third face 103, may have a crooked or lopsided smile 105, while perhaps raising one eyebrow 106 while smiling. Humans are very attentive to such minor variations in facial expressions, but they are not easily captured by systems designed to capture all kinds of movements and shapes, not only of humans, and particularly not with any priority given to variations that are relatively subtle but loaded with meaning for human observers.

A similar reasoning can be applied concerning gestures. For example, relatively minor movements of arms, hands and fingers can represent significant meaning or be representative of mannerisms that are particular to an individual and thus making a 3D representation of that individual more recognizable as that particular individual, more personal, when observed.

In order to be able to represent these minor variations in gestures and expressions without enhancing the overall capabilities of the recording equipment and increasing the data amount significantly, the present invention provides a solution wherein an additional data type, or data layer, is added. For the purposes of this disclosure, it is assumed that the starting point is a 3D modeling format, or 3D representation, which includes the 3D model itself, animation, and texture. However, the invention is not restricted to such formats, and may be used in contexts where for example one of animation and texture data is not included in the model itself but handled separately. This may for example depend on the file format being used.

Reference is now made to FIG. 2, which illustrates in a block diagram, an embodiment of a client device 200 configured to operate in accordance with the invention. It should be noted that functionality provided by the invention involves three main activities. They are capture and storage of personalization data, capture and transmission of animation data, and rendering. These activities will be described in further detail below. The client device illustrated in FIG. 2 is configured with features and capabilities related to all of these activities. It is, however, consistent with the principles of the invention to provide devices that are configured only for one, or only for two of these activities. For example, a device configured to perform capture and storage of personalization data may include more sophisticated hardware but be too bulky for use during animation (e.g. gameplay or an AR conference). Thus, personalization data may be captured by a device configured particularly for that purpose, while capture and rendering of animation is performed by dedicated devices. Another possibility is a broadcast setting where personalization and animation is captured with one type of device (e.g., studio equipment), while rendering is performed by a client device configured to operate as a receiver.

In view of this it will be understood that the description of different modules or functionality in the present disclosure is not repeated for all possible distributions of functionality across types of devices. If two or more modules are described herein as capable of interacting they may do so by being provided together in one device, or they may do so by communicating with each other over a communication link such as a computer network. Furthermore, they may be provided together in the same device regardless of whether that device does or does not include further modules that have been described as part of one embodiment herein. In other words, devices that are consistent with the principles of the invention may be provided by combining modules or features that have been described herein even if that combination has not been explicitly described or shown. Instead, the embodiments that have been described are chosen because they facilitate understanding of the invention, not because they are a complete catalog of possible embodiments.

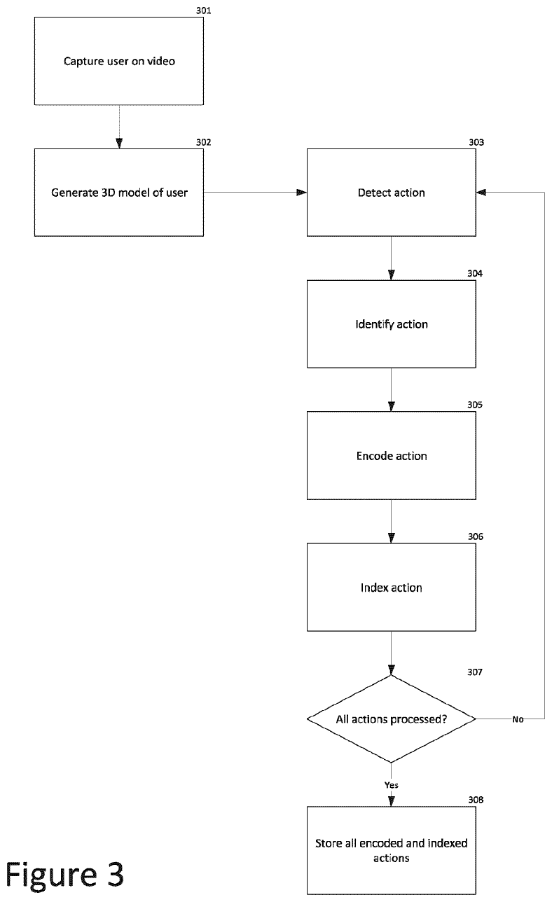

The first module in the embodiment shown in FIG. 2 is a personalization data creation module 201. This module includes or is connected to one or more cameras 202. This camera 202 is configured to capture a video of a user standing in front of the camera 202 while performing one or more often occurring actions such as turning, getting up, sitting down, various hand gestures, as well as facial expressions such as smiling, looking angry, looking disappointed, and so on. This process will be described in further detail below with reference to FIG. 3.

From the video stream delivered to the personalization data creation module 201 by the camera, a 3D model of the user is created. The 3D model may be created using photogrammetry, which, in embodiments with more than one camera 202 may include stereophotogrammetry or epipolar geometry. The personalization data creation module 201 also scans the video data stream in order to detect different motions, gestures, and expressions, collectively referred to herein as actions. The detected actions are classified and indexed, and data describing the action is stored. The data describing the action may be at least one of animation data and texture data. The classified and indexed data will be referred to as personalization data. In the drawing the personalization data creation module 201 is shown as including three sub-modules. A first sub-module 221 is a 3D model creation module. This module may use photogrammetry to create the 3D model. Some embodiments of the invention may not include this module and instead utilize a 3D model that has been (or will be) created externally to the device 200. The 3D model creation module 201 may also be a separate module rather than a part of the personalization data creation module 201. Whether a device 200 according to the invention includes a 3D model creation module or not is largely independent of whether it includes other optional features or how other features are configured.

A second sub-module 222 is a module which may be configured to analyze received video frames and detect actions. The third sub-module 223 may be configured to identify detected actions, extract action description data from the video frames, such as movement, texture or color information representative of aspects of the action. For detection and classification/identification these modules may, for example, include artificial neural networks. For extraction of action description data, motion capture techniques may be used.

The personalization data creation module 201 may include or be connected to a storage unit 203 where the personalization data can be stored. This storage unit 203 may be part of the personalization data creation module 201, it may be a separate local device, or it may be a cloud-based service. The 3D model data may be stored together with the personalization data in the storage unit 201, separately or part of the same data file, or it may be stored on a separate device. In some embodiments the 3D model may be created separately from the personalization data, in advance (in which case the 3D model may or may not be available when the personalization data is created) or later. These options and some implications will be discussed in further detail below.

The next module is an animation module 204. The animation module 204 is connected to the camera 202. In embodiments such as the one illustrated in FIG. 2 the personalization data creation module 201 and the animation module 204 may utilize the same camera 202, or they may each be connected to separate cameras, for example if it is determined during the design process for a particular embodiments that personalization data generation requires higher resolution video in order to capture details of the different actions, while animation requires lower resolution in order to limit the bandwidth necessary for data transfer. Other optical or image processing capabilities may also differ, and this will have to be determined as part of the determination of required specifications for a specific implementation of the invention. If personalization data creation and animation is performed by entirely separate devices, perhaps separated in space and time, they will require their own cameras.

The animation process performed by the animation module 204 is based on video capture of an individual performing some activity, for example related to gaming, online conferencing (VR or AR conference room). In order to animate a 3D representation of the individual as presented to other users in the shared environment, the animation module 204 may include a sub-module 231 configured to perform motion capture, and the movement of the various vertices is described as animation data. Motion capture, whether it is traditional marker-based motion capture or newer markerless techniques, and joint based as well as facial motion capture, is well known and understood in the art and will not be described in further detail here.

In addition to performing motion capture, the animation module 204 processes the video stream much in the same manner as the personalization data creation module 201. However, for the animation module 204 it is sufficient to detect and identify actions. No data describing the detected actions are captured, except to the extent that additional parameters are required, such as for example start time and duration. Instead, the animation module obtains the index for the detected action and includes that index with the animation data. For this purpose the animation module may include a sub-module 232 configured to detect actions and a sub-module 233 configured to identify detected actions and obtain indices associated with the identified actions from the storage unit 203.

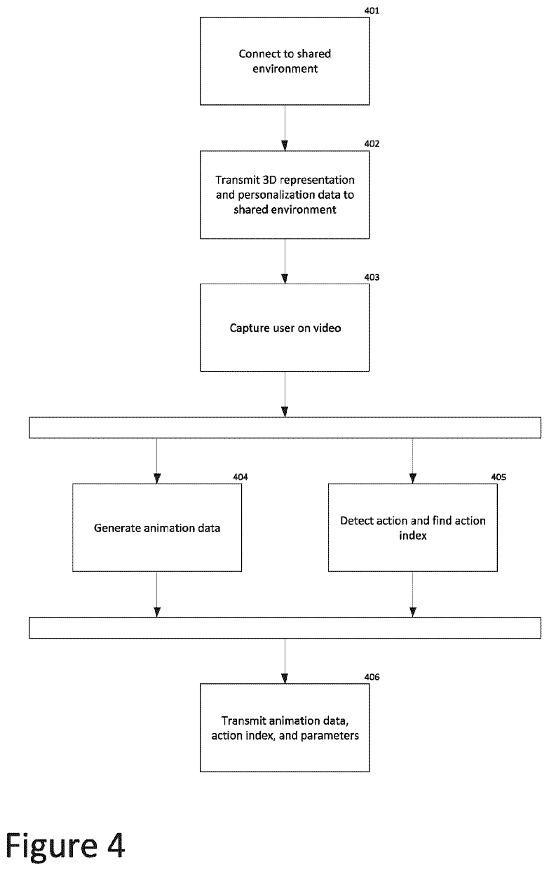

When a user connects to a shared environment the animation module 204 may obtain the 3D model representing an individual (the 3D representation) and the associated personalization data from the storage unit 203 and use a communications interface 205 to transmit the personalization data to the shared environment. The personalization data will then be available to all similar client devices connected to the shared environment. While a session of interaction is in progress the animation module 204 will transmit animation data and personalization data indices to the shared environment. The operation of the animation module 204 will be described in further detail below with reference to FIG. 4.

The last module illustrated in FIG. 2 is a rendering module 206. The rendering module 206 is connected to the communications interface 205 and to a display unit 207, for example a VR or AR headset. The device 200 may, in some embodiments, be embedded in such a headset. Also illustrated in FIG. 2 is a communication network 208 to which the communication interface 205 is connected and over which the device 200 is able to communicate with a server 209 which operates the shared environment, and with other devices 210 which also participate in the shared environment 209. It should be noted that while the drawing shows the server 209 as a single computer, the environment may be implemented on many computers, each of which may include one or many processors. These servers may all be located at the same location, or they may be distributed over many locations. In the drawing the server 209 thus represents any combination of one or many computers, and any combination or distribution of remote services associated with the shared environment, as well as the shared environment as such. When this disclosure refers to server in the singular or servers in plural, this is at each instance intended to cover both possibilities, as well as embodiments where the server 209 is part of one of the participating devices 210 or distributed among several participating devices, for example in a peer-to-peer solution.

The shared environment, whether it is or may be referred to as a virtual reality environment, an augmented reality environment, a metaverse, etc. will be referred to herein as a shared environment and with the same reference number as the server 209. Other participants in the shared environment 209 are represented in the drawing as a single display unit (a headset) 210, but there is in principle no limitation to the number of participants as long as the hardware and software used to manage the shared environment 209 has sufficient resources to handle them all.

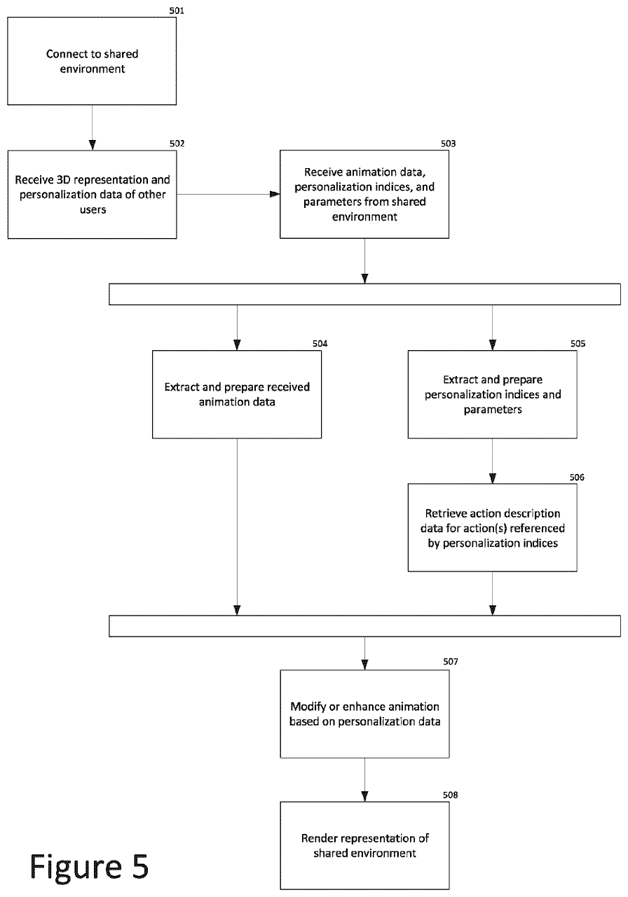

At the beginning of a session the rendering module 206 may receive 3D representations of participating individuals and associated personalization data. During the session the rendering module 206 will receive animation data and personalization index information from the shared environment 209 over the communications interface 205. The rendering module may then render (display) any 3D representations that are visible to an active user and animate that rendering based on received animation data. The received personalization index data may be used to retrieve appropriate personalization data actions from the personalization data that was received at the initiation of the session, and this personalization data may then be used to modify the rendering and/or the animation of 3D representations in a manner that will be described in further detail below with reference to FIG. 5.

It should be noted that in order to keep the drawing simple, storage unit 203 is shown as receiving data only from the personalization data creation module 201 and delivering data only to the animation module 204, which in turn transmits this information to the shared environment 209, or to some online repository where it is accessible to participants in the shared environment 209 (or directly to each participant 210). It will be understood that the storage unit 203 may be a storage device that is accessible for reading as well as writing for all the modules. For example, when the rendering module 206 receives 3D representations of participating individuals and associated personalization data, FIG. 2 assumes that this information is stored in working memory that is part of the rendering module 206. However, regardless of which other features or capabilities an embodiment may include, a device may have any combination of storage and memory devices known in the art, and memory may be shared between and accessible to all modules or some modules may control memory, or memory space, that is not accessible to other modules.

Turning now to FIG. 3, a more detailed description of embodiments of the personalization data creation module 201 will be given along with a description of methods of creating personalization data, unless otherwise stated all optional features, steps or configurations described with reference to this drawing may be combined freely with any and all embodiments of the modules that are external to the personalization data creation module 201.

The method described with reference to FIG. 3 assumes creation of a 3D model representing the individual and creation of personalization data describing mannerisms or idiosyncrasies of the individual as part of the same process. As mentioned above, these processes may be separated such that personalization data are created independently of the creation of the 3D model and the two may be combined later. This has certain implications that will be described in further detail below, including the fact that generic personalization data (which may also be referred to as default or placeholder personalization data) may be generated, and that personalization data may be transferred between individuals. Emphasis here is on the creation of personalization data, and embodiments that do not create the 3D model may not perform steps or actions related only to this.

As mentioned above, this process involves a user (individual) standing in front of a camera 202 while performing actions that are captured and used by the personalization data creation module 201 to create the 3D model (in some embodiments) and the personalization data. In a first step 301 the user is captured on video while performing certain standardized tasks. These tasks may include a standard repertoire of movements, gestures, and facial expressions, for example turning to one side, turning to the other side, sitting down, getting up, as well as certain gestures with the arms or hands. In addition the user may, for example, smile, smirk, express disappointment, excitement, anger, and so on. In some embodiments the user may also perform unscripted actions or expressions of their own.

In a next step 302 the video is processed by the personalization data creation module 201 and a 3D model of the user is generated. This may be done using methods that are well known in the art. For example, the frames of the video may be processed and the 3D model may be generated using photogrammetry. In embodiments where more than one camera 202 is available during creation of 3D model and personalization data this may involve such techniques as stereophotogrammetry and epipolar geometry. With only one camera available, 3D information may still be inferred based, for example, on how different parts of or points on the user's body move with relation to each other when the user turns. Pose estimation techniques may also be used.

After the 3D model has been generated the process proceeds to generate personalization data. This step may be subdivided into detecting 303 a specific action, identifying 304 the action, encoding 305 the action, indexing 306 the action, and storing 308 the action, and this may be repeated for several actions until the entire input video has been analyzed. These steps are illustrated in the drawing as being performed sequentially, but it is consistent with the principles of the invention to perform actions e.g., in parallel for example by detecting additional actions while already detected actions are still being encoded. Also, storing 308 the encoded actions are shown as being performed after all actions have been detected, encoded and indexed, but they may, of course, be stored as soon as they are encoded and indexed.

The detection 303 of the action may be assisted by an approximate knowledge of when the action will occur, to the extent that the video is scripted (i.e., the user has received a description of which actions to perform and in what sequence, or the user is prompted for each action). However, in order to improve detection of actions and better delineate each detected action's beginning and end, the actions may be detected using artificial intelligence (AI), in particular a machine learning (ML) method based on a deep neural network, for example a convolutional neural network (CNN). These methods may be combined with other methods such as traditional feature detection. For example, feature detection may be used to detect an action and determine the beginning and end of the action, while a neural network is used to identify the action. The AI detection of actions may also, in some embodiments, be able to detect a wider range of actions than those included in a script. As such, the user may perform a selection of actions based on their own preference and all actions the AI is able to detect as a recognizable action may be selected to be stored. Thus, users may to some extent generate personalization data not only in the sense that actions are described so as to be represented in a manner based on the user's own idiosyncrasies, but the selection of which actions that are personalized may also be specific to each user. Again, this does not mean that each user has a unique selection of actions, but that two users do not have to have the same selection of actions represented in their personalization data.

When an action has been detected it must be classified 304. This simply means that after it has been determined in step 303 that a sequence of frames contains an action, the content of those frames are analyzed to determine which action the user was performing, for example whether it was a smile, a wink, a yawn, a specific hand gesture, and so on. In some embodiments detection 303 and classification 304 may be performed by individual neural networks. In other embodiments a single neural network performs detection and classification, in which case detection and classification may be performed as a single step. These methods may also be combined with other methods such as traditional feature detection, pattern recognition, and motion detection. For example, motion detection may be used to detect an action and determine the beginning and end of the action, feature detection may be used to classify the action as a gesture or a facial expression, while a neural network may be used to identify the action.

The detected and classified actions may be encoded 305 as animation in the form of blendshapes, or blendshapes with displacements, pure frame by frame vertex changes information in a mesh, etc. These personalized changes to the 3D model mesh over time, will, regardless of which technical solution is chosen, be referred to herein as description of animation. In embodiments where the personalization data may include texture information, including color, this will be referred to as description of animation and/or texture.

Each detected and encoded action will be indexed in step 306. The index serves to identify a specific action such that when that specific action is detected during a user's interaction with a shared environment 209, the corresponding description of animation and/or texture can be retrieved, as will be described in further detail below. It will be realized that indexing may follow different schemes in different embodiments. The library comprising a set of actions for a particular individual will be associated with that individual, so the indices for the various actions only have to be unique locally. However, it is consistent to operate with indices that are globally unique, i.e. such that the index not only identifies the action but also the individual with which it is associated. Furthermore, some embodiments may operate with static indices in the sense that, for example, a smile always has the same index for all individuals, while other embodiments may generate indices randomly as actions are detected and encoded.

A process of determining whether all actions have been processed is illustrated as a next step 307. As long as there are remaining frames that have not been analyzed or detected actions that have not been classified, encoded, and indexed, the process will return to step 303. (It will be realized that there may be more than one loop running concurrently. As such, action detection may continue until all frames have been processed, classification may be repeated until all detected actions have been classified, encoding may be repeated until all classified actions have been encoded, and indexing may be repeated until all encoded actions have been indexed.)

After it has been determined in step 307 that all detected actions have been processed, they are stored in step 308 as a library of personalization data in storage unit 203.

In some embodiments of the invention the detection algorithm 303 may also be configured to perform prediction. In such embodiments the algorithm infers undetected actions, i.e., actions the user did not perform in the video, by basing them on related actions that have been detected. For example, given that a user has provided a smile as one of the detected actions, the algorithm may predict how the user will show excitement and generate a description of corresponding animation. In this way richer personalization data can be generated than what has actually been displayed by the user, providing a richer repertoire of personalized gestures and expressions. It will be realized that the number of actions included in the personalization data will increase the file size. Some embodiments may therefore prioritize between actions based on available storage space or bandwidth, or this can be made a user configurable parameter.

After the personalization data has been generated by the personalization data creation module 201 and stored in the storage unit 203 it is available to be used as part of a user's interaction with a shared environment 209. Reference is now made to FIG. 4, which illustrates in a flow chart the principles of how a client device may establish a connection to a shared environment 209 and start interaction.

In a first step 401 the device 200 connects to a shared environment 209. This process may involve authentication and authorization based on user credentials (e.g., passwords), and other handshaking procedures in order to set up the parameters for the underlying communication protocols. This is well known in the art and will not be described further herein.

In a following step 402 the 3D representation of the user is transmitted to the shared environment 209 along with the personalization data. This enables the server or servers operating the shared environment 209 to distribute this representation and the personalization to other participating devices 210. In some embodiments, for example in peer-to-peer solutions or one-to-one interaction, this information is sent directly to a corresponding device and not to a server computer.

It should be noted that the initial steps, or processes, described above initialize a session and enable a device 200 to interact with a shared environment. In most cases these steps are only performed once when a session is started. The following steps in FIG. 4, however, are ongoing during the session and should be understood more as a pipeline of processes than discrete steps performed sequentially. These steps are mainly the responsibility of the animation module 204.

After initialization, the process moves to step 403 where the user is captured on video using the camera 202 connected to the animation module 204. As already mentioned, this may be the same camera as the one used by the personalization data creation module 201 or a different camera, depending on the design and configuration choices made for a particular embodiment. This step 403 will be an ongoing process that may continue with or without interruptions as long as the user interacts with the shared environment 209.

The captured video from step 403 is delivered as a stream of video frames to two processes that may be running in parallel. In one process 404 animation data is generated from the captured video through motion capture. This may be performed by a motion capture submodule that is part of the animation module 204 using techniques that are well known in the art. The animation data may be in the form of description of movement, for example of joints in a skeletal representation and of vertices in a mesh. In a process running in parallel with the motion capture performed in process 404, a process 405 of detecting actions and finding a corresponding action index is performed. This process 405 may be based on artificial intelligence and corresponds to that which is performed in order to detect and identify actions by the personalization data creation module 201, as described with reference to FIG. 3. Actions (e.g., gestures or expressions) performed by the user are identified from the received video frames and the index referring to the description of that action in the personalization data library is provided as output along with any necessary parameters such as, for example, start time and duration. Then, in a following process 406 the animation data from process 404 is transmitted to the shared environment 209 along with the action index and parameters from process 405.

The process just described may involve details relating to color, texture, additional objects in the scene (i.e., other objects than the user), light, and sound. These aspects will not be described in further detail, but it will be understood that they can be integrated with (or part of) the information already described. In particular, animation data may in all cases be generalized to include texture and color. Also, detection and identification of actions may be supported by other information than that which is present in the video frames. For example, if laughter or certain words are detected in an audio signal, this may be used to identify a corresponding action and the index for that action may be included in the data transmitted in process 407.

Turning now to FIG. 5, a description of the processing performed by the rendering module 206 will be given. As with the examples above, this is done in the form of an exemplary embodiment, variations of which are within the scope of the invention.

In a first step 501 the device 200 connects to a shared environment 209. This corresponds to step 401 in FIG. 4. Indeed, for devices that interact with the shared environment by receiving data from the shared environment as well as transmitting data to the shared environment this step may be performed only once in order to connect both the animation module 204 and the rendering module 206 to the shared environment. As such, step 401 and step 501 may be one and the same step.

In a step 502 3D representations of one or more other participants in the shared environment 209 are received along with their respective personalization data. This information may be stored in working memory accessible to the rendering module 206, as described above.

As with FIG. 4, the first two steps in FIG. 5 initialize a session and enable a device 200 to interact with a shared environment. The following steps in FIG. 5 focus on the reception of remote information from the shared environment, or from individual remote devices, and the processing of this information as performed by the rendering module 206. Again, these are steps that may be understood as processes in a pipeline rather than steps that are performed sequentially.

In step 503 animation data along with personalization indices are received from at least one remote device is received, either directly from the remote device or from a server operating the shared environment. It will be understood that whether data is received from remote devices directly or from a server depends on the embodiment of the underlying platform and that choices may be made based on the need to reduce latency—which could be done by communicating directly between devices—and the need to coordinate position and movement of many objects including characters—which could be done by utilizing a server. For the purposes of this disclosure either alternative may be chosen, and this aspect will therefore not be discussed in further detail.

In a next step, or process, 504 the received animation data is extracted and prepared such that it can be applied to the local representation of the shared environment. In particular, animation of a 3D representation of a remote user (or other character) is prepared. This is in the main performed in accordance with traditional animation but may include preparation for the following step.

In parallel with the extraction of animation data, a step, or process, 505 extracts personalization indices and any associated parameters from the received data stream. The personalization indices refer to specific actions in the personalization data file, or library, received in step 502 and the relevant data describing a referenced action may now be retrieved 506. In a subsequent process 507 the animation data from step 504 may be modified or enhanced based on the retrieved personalization data and any received parameters. The output from this process may then be rendered 508 as a representation or animation of the shared environment 209, or one or more 3D representations that are part of that environment.

The result that is made visible to a user is that 3D representations are animated not only based on motion capture. Instead the animation is enhanced by the personalized actions that may include gestures, facial expressions, changes in color or texture, or in other ways that may be too subtle to be registered by motion capture, but still very noticeable to a user because they relate to actions humans pay particular attention to. Furthermore, by providing a library of such action descriptions during, or even prior to, initialization of a session it is only necessary to transmit indices referencing these actions during a session. This greatly reduces the bandwidth required and may thereby also reduce latency.

It will be realized that in embodiments of devices 200 that include personalization data creation module 201, animation module 204, and rendering module 206, the device 200 may be configured to perform all the methods described above. However, it is consistent with the principles of the invention to provide only one of these modules, and only the corresponding method, in a device. A device providing only the personalization data creation module 201 could be one that is intended to be used, for example, in a studio environment in order to create 3D models and personalization data that can later be used by other devices. A device providing only the animation module 204 could be one that is intended to be used to broadcast animation, for example of a performance of actors or musicians on stage. Correspondingly, a device with only the rendering module 206 could be one intended for receipt of such broadcasts. Furthermore, a device with personalization data creation module 201 and animation module, but without the rendering module 206, could be a device intended for studio production and broadcast, while a device with an animation module 204 and a rendering module 206 but without any personalization data creation module 201, could be one that is intended for interaction in a shared environment based on 3D representations created in advance using a different device.

In principle, it is also possible to provide devices with a personalization data creation module 201 and a rendering module 206 but no animation module 204, but the valuable use cases for such a configuration may be limited.

It will also be realized that in embodiments with two or more of the described modules and configured correspondingly with two or more of the methods described above, the implementation of the respective modules, and methods, do not depend on each other in any strict sense. As such, embodiments of the respective modules may be combined with any embodiment of the other modules described herein.

As already mentioned, 3D models and personalization data may in principle be created independently. This may require a standardization with respect to representation and animation. This creates certain possibilities. One such possibility is that already existing 3D models of a user may be enhanced later with personalization data. Another possibility is the establishment of default personalization data. In this case personalization data should not be understood as being personal in the sense that it is created by or for a particular person or character, but that it takes the place of such data in order to enable gestures and expressions that might make a 3D representation appear more personal through the user of human gestures and expressions even if they in this case would be generic. This could be valuable in cases where a 3D representation is available but without personalization data. Such generic personalization data could be available from an online repository, for example one that is associated with the server operating the shared environment 209.

A further development of this aspect is to apply personalization data for one user to be applied to a 3D representation of a different user (or of a synthetic character). This would mean that if the personalization data for user A were applied to the 3D representation of user B, user B would still look the same, but the 3D representation would start to display mannerisms that would be reminiscent of user A. For example, if user A has a characteristic way of smiling while raising one eyebrow, user B would start to smile in the same way. This principle may be applied to synthetic characters and/or synthetic personalization data (i.e., characters or personalization data that has been artificially designed rather than based on an actual person). The result could, for example, be that a 3D representation of a real user would start to perform actions reminiscent of a cartoon character, or a cartoon character could start to move and grimace like a famous musician on stage.

While the default scenario described above involves detection of actions by the animation module 204 on the transmitting side, the invention may provide additional flexibility or enhancements. If one participant in a shared environment 209 is using a device 200 with animation capabilities, but without any personalization data, animation information will be transmitted to the shared environment unaccompanied by personalization data. Some embodiments of the invention may then include action detection capabilities in the rendering module 206. It will be realized that in this case the action detection cannot be based on video frames but will have to be based on animation data and other information, for example audio. Some examples could be that detection of hand clapping in the animation data could trigger smiling from the personalization data, or the word “bravo” in the audio stream could trigger a hand clapping gesture. It will be realized that in this case the device providing the animation data has probably not provided a library or file of personalization data (although this information could be available for example from an online repository even if the device currently being used by the user lacks action detection). If personalization data is not available the rendering module may use default or placeholder personalization data as described above.

Similarly, the rendering module 206 could be configured to enhance the behavior of a 3D representation by adding actions that have not been identified by any received personalization index based on actions that have. For example, the rendering module 206 could be configured to add clapping of hands if an index referencing a facial expression of excitement has been received.

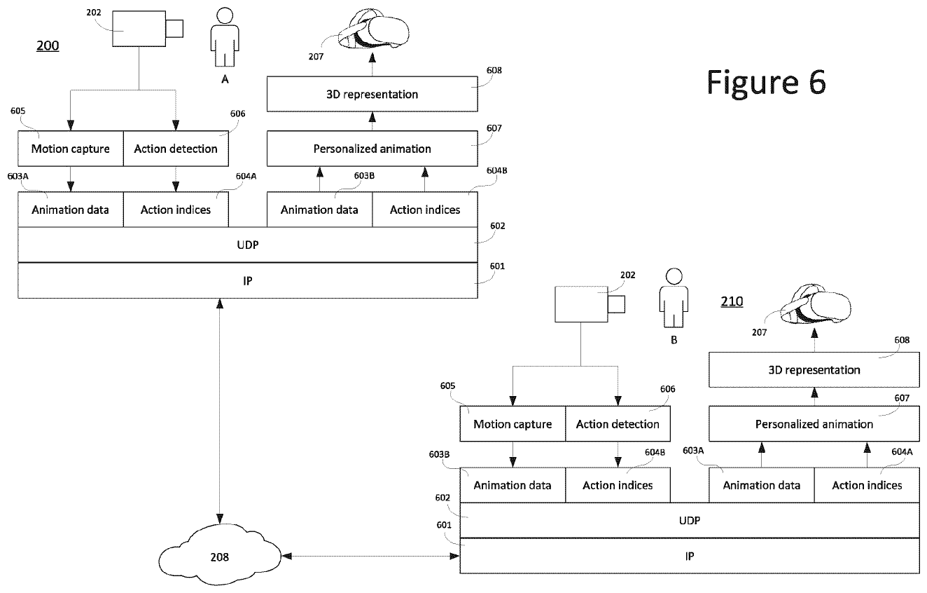

Reference is now made to FIG. 6, which illustrates the data flow between two devices 200, 210 during a session of interaction in a shared environment. The devices communicate over a communication network 208 which in this case may be assumed to include any additional participants as well as any server or servers used to manage the shared environment. The same numerals will be used to reference elements of both devices 200, 210. With respect to the data that is present on both devices the reference numerals are appended with A and B respectively in order to indicate the origin of the data. Users A and B are observed by the respective cameras 202 and thus represented in the stream of videoframes provided as input.

Although several protocols are known in the art and may be used in embodiments of the invention, this example uses the internet protocol (IP) 601 to carry the user datagram protocol (UDP) 602. Additional protocol layers may be present on top of these, but they may be application specific and may be thought of as containers for the application data which are illustrated as containing two parts, namely animation data 603 and action indices 604. The animation data 603 is obtained as output from a motion capture process 605 and action indices, along with any relevant parameters, are provided from an action detection process 606. These processes are described above with reference to FIG. 4. Both of these processes receive video frames from a video camera 202 and may run in parallel.

The UDP and IP layers are used to transport this data from the local device to the shared environment, as well as from the shared environment to the local devices. With respect to device 200 in the drawing this is shown as animation data 603A and action indices 604A which is generated and transmitted, and animation data 603B and action indices 604B which is received from another device, in this case from device 210. It will be noticed that with respect to device 210 the transmitted data includes animation data 603B and action indices 604B while the received data includes the animation data 603A and action indices 604A generated and transmitted by device 200.

The received animation data 603 is enhanced with personalized data identified by the received action indices 604 in a process described above with reference to FIG. 5. The output from this process 607 is applied to the 3D representation of the remote user which may then be rendered by a display device 207.

The various modules, features, and configurations that have been described herein may be implemented using a combination of hardware and software components in a manner that will be readily understood by those with skill in the art. Generic components such as processors, communication buses and interfaces, user interfaces, power sources, memory circuits and devices, and the like have not been described in detail since they are well known to persons skilled in the art.

1. A method in a computer system of creating a library of personalization data for use in animation of a 3D model representing a human or a humanoid character in a shared environment, comprising:
obtaining (301) a video stream of a user while the user is performing a sequence of actions;
providing frames from the video stream as input to a computerized process of analyzing the frames in order to detect (303) one or more actions performed by the user;
identifying (304) the detected one or more actions;
for the detected one or more actions, extracting action description data from the video frames and storing (308) the action description data in a library of personalization data, the action description data including encoded aspects of the detected one or more actions; and
associating (306) each stored action description with an index.

2. A method according to claim 1, further comprising:
providing frames from the video stream as input to a computerized process of photogrammetry to generate 3D information about the user;
using the 3D information to generate a 3D representation of the user; and
storing the 3D representation of the user as a 3D model that may be represented and animated in the shared environment.

3. A method according to claim 1, wherein at least one of analyzing the frames in order to detect one or more actions and identifying the one or more detected actions, is performed by a machine learning subsystem (222, 223) that has been trained to perform at least one of detecting and identifying actions in a stream of video frames.

4. A method according to claim 3, wherein the machine learning subsystem includes at least one artificial neural network.

5. A method according to claim 1, further comprising:
inferring, based on the action description data for at least one detected action, an estimated action description for at least one action that has not been detected; and
storing and indexing the estimated action description in the library of personalization data.

6. A method according to claim 1, wherein the action description includes at least one of: animation data, texture data, and color data.

7. A method in a computer system of providing personalization data together with animation data for animation of a 3D model representing a human or a humanoid character in a shared environment, comprising:
connecting (401) to the shared environment;
transmitting (402), to the shared environment, a library of personalization data holding action description data including encoded aspects of one or more actions, each action description being associated with an index;
obtaining (403) a video stream of a user while the user is performing actions;
providing frames from the video stream as input to a computerized process of motion capture to generate (404) animation data from user movement represented in the video stream;
providing frames from the video stream as input to a computerized process of analyzing the frames in order to detect (405) and identify at least one action corresponding to an action represented in the library of personalization data; and
transmitting (406) the generated animation data and the index for the detected and identified at least one action to the shared environment.

8. A method according to claim 7, wherein at least one of detecting one or more actions and identifying the one or more detected actions, is performed by a machine learning subsystem that has been trained to perform at least one of detecting and identifying actions in a stream of video frames.

9. A method according to claim 8, wherein the machine learning subsystem includes at least one artificial neural network.

10. A method according to 7, wherein the action description includes at least one of: animation data, texture data, and color data.

11. A method in a computer system of applying personalization data to animation data when animating a 3D model representing a human or a humanoid character in a shared environment, comprising:
connecting to the shared environment;
receiving a library of personalization data holding action description data including encoded aspects of one or more actions, each action description being associated with an index;
receiving animation data and at least one index referencing an action represented in the library of personalization data;
using the at least one index to retrieve action description data from the library of personalization data;
applying retrieved action description data to the animation data to generate personalized animation data; and
rendering and animating the 3D model in accordance with the personalized animation data.

12. A method according to claim 11, further comprising receiving the 3D model together with the library of personalization data.

13. A method according to claim 11, wherein the library of personalization data is received from a repository connected to a computer network, and the animation data and the at least one index referencing an action represented in the library of personalization data is received from a device participating in the shared environment.

14. A method according to claim 13, wherein the personalization data was generated independently from the generation of the 3D model.

15. A computer device for creating a library of personalization data for use in animation of a 3D model representing a human or a humanoid character in a shared environment, comprising:
at least one video camera (202);
a personalization data creation module (201) configured to receive frames from the at least one video camera (202), and including a sub-module (222) configured to analyze received video frames and detect actions performed by a user depicted in the video frames, and a sub-module (223) configured to identify detected actions and extract action description data including encoded aspects of the detected one or more actions, and associating (306) each action description with an index; and
a storage unit (203) configured to receive and store personalization data received from the data creation module (201).

16. A computer device according to claim 15, further comprising a 3D model creation module (221) configured to receive frames from the at least one video camera (202) and use photogrammetry processing of the video frames to generate a 3D model based on images of a person represented in the received video frames.

17. A computer device according to claim 15, wherein at least one of the sub-module (222) configured to detect actions and the sub-module (223) configured to identify actions comprises an artificial neural network.

18. A computer device for providing personalization data together with animation data for animation of a 3D model representing a human or a humanoid character in a shared environment (209), comprising:
a storage unit (203) storing a library of personalization data holding action description data including encoded aspects of one or more actions, each action description being associated with an index;
a video camera (202);
an animation module (204) configured to receive frames from the at least one video camera (202), and including a sub-module (231) configured to perform motion capture processing of the received video frames to generate animation data from movements performed by a person represented in the video stream, a sub-module (232) configured to analyze video frames and detect actions performed by a person depicted in the video frames, and a sub-module (233) configured to identify detected actions and obtain indices associated with identified actions from the storage unit (203); and
a communications interface (205) configured to transmit the library of personalization data, animation data and action indices to the shared environment (209).

19. A computer device according to claim 18, wherein at least one of the sub-module (222) configured to detect actions and the sub-module (223) configured to identify actions comprises an artificial neural network.

20. A computer device for applying personalization data to animation data when animating a 3D model representing a human or a humanoid character in a shared environment, comprising:
a communications interface (205) for receiving a library of personalization data holding action description data including encoded aspects of one or more actions, each action description being associated with an index, animation data and indices referencing actions represented in libraries of personalization data from the shared environment (209);
a rendering module (206) configured to include the 3D model in a local representation of the shared environment (209), to retrieve action description data referenced by received indices from the library of personalization data, to apply retrieved action description data to animation data to generate personalized animation data, and to render and animate the 3D model in accordance with the personalized animation data; and
a display unit (207) configured to visualize at least a part of the shared environment (209) including rendered and animated 3D models.
